(19) United States
(12) Patent Application Publication
(10) Pub. No.: US 2008/0065835 A1
(43) Pub. Date: Mar. 13, 2008

(54) OFFLOADING OPERATIONS FOR MAINTAINING DATA COHERENCE ACROSS A PLURALITY OF NODES

(75) Inventors: Sorin Iacobovici, San Jose, CA (US); Rabin A. Sugumar, Sunnyvale, CA (US)

Correspondence Address: Sun Microsystems, Inc.;c/o DARBY & DARBY P.C., P.O. BOX 770, Church Street Station, NEW YORK, NY, 10008-0770, US

(73) Assignee: Sun Microsystems, Inc., Santa Clara, CA (US)

(21) Appl. No.: 11/530,799

(22) Filed: Sep. 11, 2006

(51) Int. Cl. G06F 13/00

(52) U.S. Cl. 711/141

(57) ABSTRACT

Offloading data coherence operations from a primary processing unit(s) executing instantiated code responsible for data coherence in a shared-cache cluster to a data coherence offload engine reduces resource consumption and allows for efficient sharing of data in accordance with the data coherence protocol. Some of the data coherence operations, such as consulting and maintaining a directory, generating messages, and writing a data unit can be performed by a data coherence offload engine. The data coherence offload engine indicates availability of the data unit in the memory to the appropriate instantiated code. Hence, the instantiated code (the corresponding primary processing unit) is no longer burdened with some of the work load of data coherence operations. Migration of tasks from a primary processing unit(s) to data coherence offload engines allows for efficient retrieval and writing of a requested data unit.

### BACKGROUND

1. Field of the Invention

The invention generally relates to the computational field, and, more specifically, to sharing of data in a shared-cache cluster.

2. Description of the Related Art

Clusters have become increasingly popular due to their cost and reliability advantages. Clusters are made of multiple systems (e.g., single chip system, symmetric multiprocessor (SMP) system, etc.) networked together, each system having its own address space. For some database implementations, a shared-cache cluster architecture is employed. In database applications implemented over a shared-cache cluster architecture, data is shared between multiple database instances by sharing data units. Disk access is slow, however, so ensuring data consistency (coherency) by saving a modified block to disk before another requester can access it results in poor performance. This problem can be addressed by keeping track of the state of blocks in the different instances' memory, and by providing software that achieves coherency with invalidate messages and block transfers between different database instances, rather than saving data units to and retrieving them from disk. Using such a shared-cache cluster architecture improves performance relative to the disk coherency solution, but the overall performance is still inferior relative to the same database instances running on an SMP system, which has one address space and fully implements coherency in hardware.

To maintain data coherence among the nodes of a shared-cache cluster, the nodes adhere to a coherence protocol that requires marking of data units and transmission of messages to perform the following: confirm receipt of data units, request data units, and update state of a data unit. The messages are generated and processed by database application instances. For example, application instance 1 on node A requests a data unit. Application instance 2 on node B receives the request and processes the request. The application instance 2 generates a message with the requested data unit and transmits the generated message to application instance 1 on node A. When node A receives the message, application instance 1 is interrupted so that application instance 1 can handle the message. The message is parsed by application instance 1, and, eventually, application instance 1 writes the requested data unit to memory. The processing by the database application instances encumbers their respective processors, and negatively impacting performance of their host node. The messages also incur overhead from traversing the upper layers of the network protocol stack. For example, each of the messages is layered with the services and functionality provided by TCP/IP, as well as encapsulation overhead of the application. This encapsulation overhead consumes network bandwidth as well as processing unit resources for decapsulation operations. Moreover, licensing cost of software is generally a function of a number of cores used to execute the licensed software. An additional core or processor may be utilized to execute code that performs operations to maintain data coherence in a cluster of nodes in a shared-cache cluster, resulting in higher software licensing costs.

### SUMMARY

It has been discovered that at least a portion of the functionality for implementing data coherence in a shared-cache cluster can be offloaded from primary processing units executing instantiated code that performs the functionality to a data coherence offload engine. The offloading reduces the burden on a node's primary processing unit(s) and frees resources typically consumed by performing the operations for data coherence (e.g., accessing memory, generating messages, examining messages, etc.). Offloading also allows the overhead of protocols at upper layers of a protocol stack to either be shifted off of the primary processing unit(s) to the offload engine or to be at least partially avoided. In addition, offloading may reduce cost of licensing software, since a core is not being used to execute code that performs the functionality being offloaded to the data coherence offload engine. At a requestor node, a data coherence offload engine handles a data request initiated by an instantiated code executed on the requestor node's primary processing unit(s). The data coherence offload engine may locally determine a current owner node for a requested data unit, query another node for the current owner node, etc. Assuming the request data unit is available, a current owner node's data coherence offload engine supplies the requested data unit to the requester node. After receiving the requested data unit, the requestor node's data coherence offload engine writes the data unit to memory and indicates availability of the data unit to the instantiated code.

### BRIEF DESCRIPTION OF THE DRAWINGS

The present embodiments may be better understood, and its numerous objects, features, and advantages made apparent to those skilled in the art by referencing the accompanying drawings.

FIG. 1 depicts an example cluster efficiently supplying a requested data unit.

FIG. 2 depicts an example source supplying a requested data unit to a data coherence offload engine of a requestor node.

FIGS. 4A-4B depict example data sharing between nodes of a cluster from the perspective of protocol stack instances. FIG. 4A depicts an example data unit request in a cluster of nodes from the perspective of protocol stack instances. FIG. 4B depicts an example data unit response in a cluster of nodes from the perspective of the protocol stack instances.

FIG. 5 depicts example hardware components of an interconnect adapter for offloading block coherency functionality to a data coherence offload engine.

FIG. 6 depicts an example computer system.

The use of the same reference symbols in different drawings indicates similar or identical items.

### DESCRIPTION OF EMBODIMENT(S)

The description that follows includes exemplary systems, methods, techniques, instruction sequences and computer program products that embody techniques of the present invention. However, it is understood that the described invention may be practiced without these specific details. For instance, although depicted examples refer to protocol stack instances that correspond to the OSI reference model, embodiments are not limited to any particular implementation of protocols and may be realized in accordance with any of a variety of stack models, such as the TCP/IP four layer model. In addition, the description often depicts an example with an offload engine that performs many of the operations for handling a data request and maintaining data coherence. It should be understood that the amount of tasks performed by an offload engine may vary from a minimalist approach, perhaps entrusting the offload engine with operations that do not involve message generation, to a more substantial offload of tasks. In other instances, well-known instruction instances, protocols, structures and techniques have not been shown in detail in order not to obfuscate the description.

The following description refers to a data unit, a shared-cache cluster, a primary processing unit, a instantiated code and a data coherence offload engine. A data unit refers to transmission and/or request granularity of data, such as a block or a file. A primary processing unit refers to a processing unit (or possibly multiple processing units), whether having a single core or multiple cores, that acts as a primary processing unit for a node. For example, a node may have a set of one or more processing units responsible for core tasks and another processing unit responsible for encryption and decryption. The encryption/decryption processing unit would not be considered the primary processing unit in such an example. An instantiated code is realized as one or more pieces of code, executed by one or more processing units, that performs one or more tasks. Examples of an instantiated code include a process, a thread, an agent, application (e.g., a database) binary, operating system binary, etc. A data coherence offload engine is a mechanism, such as programmable logic, substantially implemented with hardware distinct from the primary processing unit of a node. Although a portion of the task(s) performed by the offload engine may be realized with execution of instruction instances, a substantial portion of the task(s) is performed by one or more hardware components. Example offload engines may comprise one or more of an application specific integrated circuit (ASIC), a field programmable gate array (FPGA), a complex programmable logic device, etc. Regardless the implementation specifics, a simple offload engine (hardware with less capability and structures than a processor) allows for transfer of tasks without the high cost of a processor. A shared-cache cluster is a cluster of nodes with memory that collectively act as cache for back-end storage. A cluster may be realized as a network of systems or a network of processing units. For example, nodes may be individual systems. The dynamic random access memory of these individual systems collectively act as a cache for back-end disk-based storage. In another example, nodes are individual chips with shared cache for a shared random access memory based storage. Regardless of the particular realization, a shared-cache cluster provides faster access to data in storage.

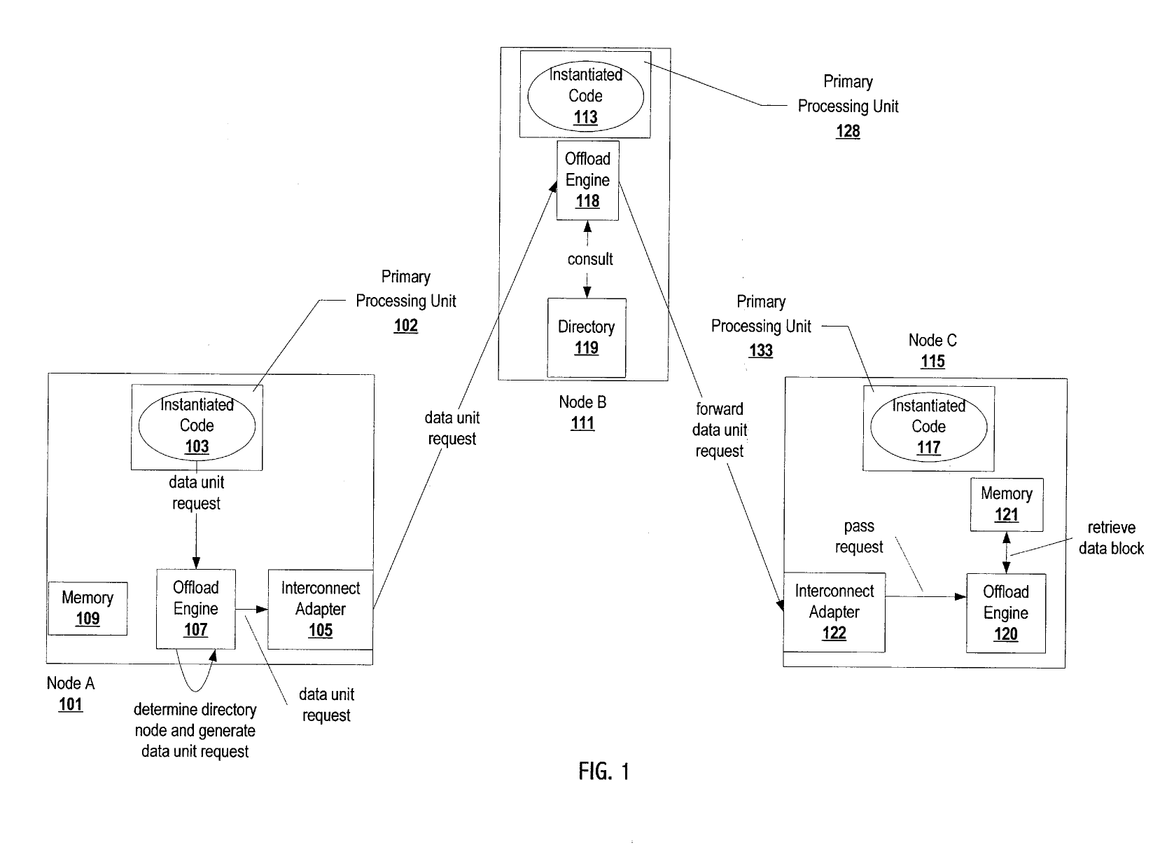

FIG. 1 depicts an example cluster efficiently supplying a requested data unit, In FIG. 1, the cluster includes a node A 101, a node B 111 and a node C 115. The node A 101 includes a primary processing unit 102, an instantiated code 103 (from a database application and/or an operations system for instance), a memory 109, a data coherence offload engine 107 and an interconnect adaptor 105. The memory hosts an address space accessible by the instantiated code 103 and/or an instantiated code associated with the instantiated code 103. The node B 111 includes a primary processing unit 128, an instantiated code 113, an offload engine 118, and a directory 119. The node C 115 includes a primary processing unit 133, an instantiated code 117, an interconnect adaptor 119, an offload engine 120, and a memory 121. The instantiated codes 103, 113, and 117 are executed by the primary processing units 102, 128, and 133, respectively.

In the node A 101, the instantiated code 103 initiates a data unit request. The data unit request is communicated to the data coherence offload engine 107. Any of a number of techniques can be employed to facilitate communications between executing code on a primary processing unit and a data coherence offload engine. For example, communication may be facilitated between an instantiated code and the offload engine with a queue. In such an example, instantiated code pushes requests to the tail of the queue while the offload engine pops requests from the head of the queue for processing. It should be appreciated by those of ordinary skill in the art that reference to pushing and popping to a queue is merely illustrative and not meant to be limiting upon embodiments. A variety of structures, whether implemented in one or both of hardware and software, may be implemented to facilitate communication. The data coherence offload engine 107 determines the node in the cluster that hosts the directory. In some implementations of a shared-cache cluster, the requestor node may host the directory or a portion of the directory. If node A 101 hosts a portion of the directory, then the data coherence offload engine 107 consults the local directory portion to determine if it indicates a location of the requested data unit. If the location of the data unit cannot be determined at the requestor node A 101, then the data coherence offload engine 107 generates a data request and transmits the data request to node B 111 via the interconnect adaptor 105. The offload engine 118 at the node B 111 consults the directory 119 to determine a location of the requested data unit. In this illustration, the directory 119 indicates that the location of the requested data unit is node C 115. The offload engine 118 forwards the data unit request to the node C 115. The data unit request is received at the interconnect adaptor 119, and then forwarded to the offload engine 120. The offload engine 120 accesses the memory 121 to retrieve the data unit. If the operations become too complex for the offload engine, then the offload engine defers to the instantiated code on the corresponding primary processor unit. For example, if the node B 111 receives a batch of requests or certain requests related to database recovery operations, then the offload engine forwards the requests to the instantiated code 113 on the primary processing unit 128.

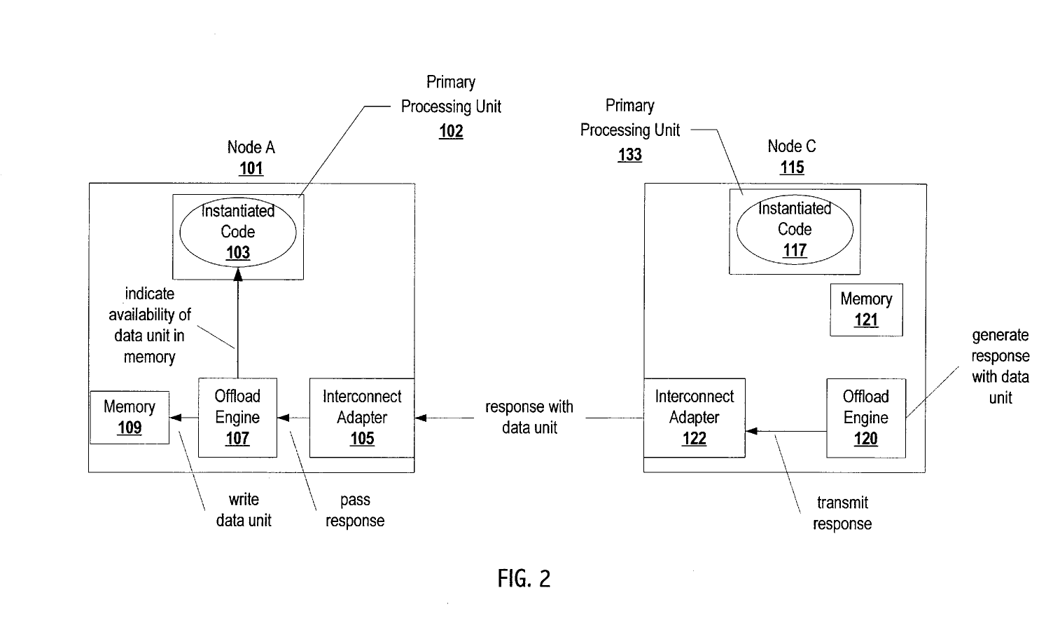

FIG. 2 depicts an example source supplying a requested data unit to a data coherence offload engine of a requestor node. After retrieval of the requested data unit from memory 121, the instantiated code 117 generates a response with the retrieved data unit. The response is then transmitted via the interconnect adaptor 119 to the requester node A 101. At node A 101, the interconnect adaptor 105 receives the response with the data unit and passes the response to the data coherence offload engine 107. The data coherence offload engine 107 writes the requested data unit to the memory 109 or address space hosted by the memory 109. After writing the requested data unit (or in parallel with the writing, immediately prior to the writing, etc.), the data coherence offload engine 107 indicates availability of the data unit in the memory 109 to the instantiated code 103. Availability of the requested data unit can be realized with various techniques. For example, the data coherence offload engine 107 may generate an interrupt to the processing unit supporting the instantiated code 103. In another example, the data coherence offload engine 107 sets a value in a special register or designated register, which is polled by the instantiated code 103 (or another instantiated code that interacts with the instantiated code 103). Offloading tasks to the data coherence offload engine 107 (e.g., accessing and maintaining a directory, generating messages, writing the requested data unit to the memory 109) allows the requested data unit to be written to memory efficiently. Offloading of tasks from an instantiated code to a data coherence offload engine also frees resources of the primary processing unit executing the instantiated code. Hence, reducing the burden on the instantiated code reduces workload on the primary processing unit, which reduces consumption of resources, such as registers, cycle time, bus bandwidth, etc. Offloading also allows resources to be conserved by obviating some protocol overhead.

FIGS. 3A-3B depict example data coherence offloading that avoids some protocol overhead from the perspective of protocol stack instances. FIG. 3A depicts an example data unit request in a cluster of nodes from the perspective of protocol stack instances. In FIGS. 3A-3B, a protocol stack instances 301, 303, and 305 respectively correspond to a requester node, a directory node, and a current owner node. Although FIG. 3A depicts a protocol stack instance for a directory node, the directory or a portion of the directory may reside on either one of or both of a requestor node and a current owner node. It should be understood by those of ordinary skill in the art that the protocol stack instances are merely for illustrative purposes. It is well known that some applications and/or services do not adhere strictly to a particular stack model and that the protocol stack models are provided for guidance. An instantiated code initiates a data unit request at the application layer of the protocol stack instance 301, and passes the request to an offload engine at the network layer of the protocol stack instance 301. It should be appreciated by those of ordinary skill in the art that an offload engine may correspond to any one or more of the layers of a protocol stack (e.g., transport, network, data link, etc.). As already stated, the protocol stack acts as a suggested model, and is utilized herein for illustrative purposes. The offload engine determines a destination for the request (e.g., examines a directory, determining the node that hosts the directory, etc.), and generates a data unit request. The generated data unit request travels down the protocol stack instance 301 and is transmitted to a node that corresponds to the protocol stack instance 303.

The request travels up the protocol stack instance 303 to the network layer, where an offload engine receives the request and locates a current owner node for the requested data unit. After determining a current owner node, the offload engine forwards the request to the current owner node. After the request travels down the protocol stack instance 303, it is transmitted to a node that corresponds to the protocol stack instance 305.

The forwarded request travels up the protocol stack instance 305 and is received by an offload engine at the network layer of the protocol stack instance 305.

FIG. 3B depicts an example data unit response in a cluster of nodes from the perspective of the protocol stack instances. At the protocol stack instance 305, the offload engine retrieves the requested data unit and forms a response with the data unit. The response with the data unit travels down the protocol stack instance 305 from the network layer to the physical layer, and is then transmitted to the node that corresponds to the protocol stack instance 301. The response with the data unit travels up the protocol stack instance 301 from the physical layer to the network layer, where the response is delivered to the offload engine. The offload engine writes the data unit to memory. As indicated above, in various embodiments the data unit may be delivered to the offload engine at the network layer, transport layer, a layer that corresponds to a portion or all of either one of the network layer and the transport layer, application layer, etc. The offload engine then indicates to the instantiated code that the data unit is available in the memory.

Example Configuration

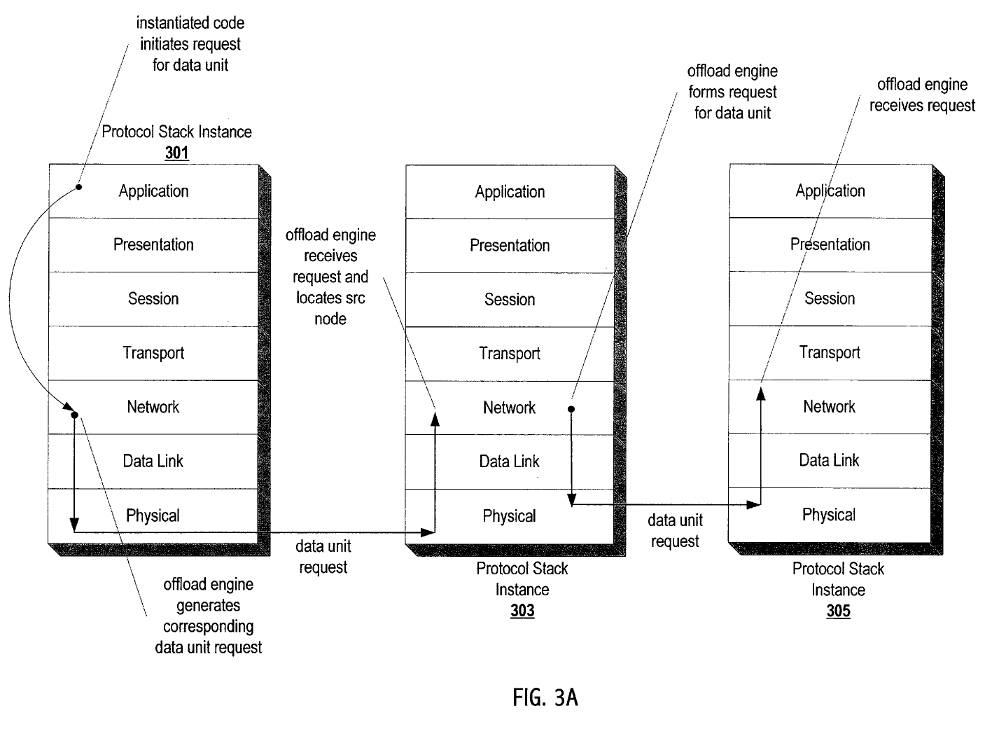

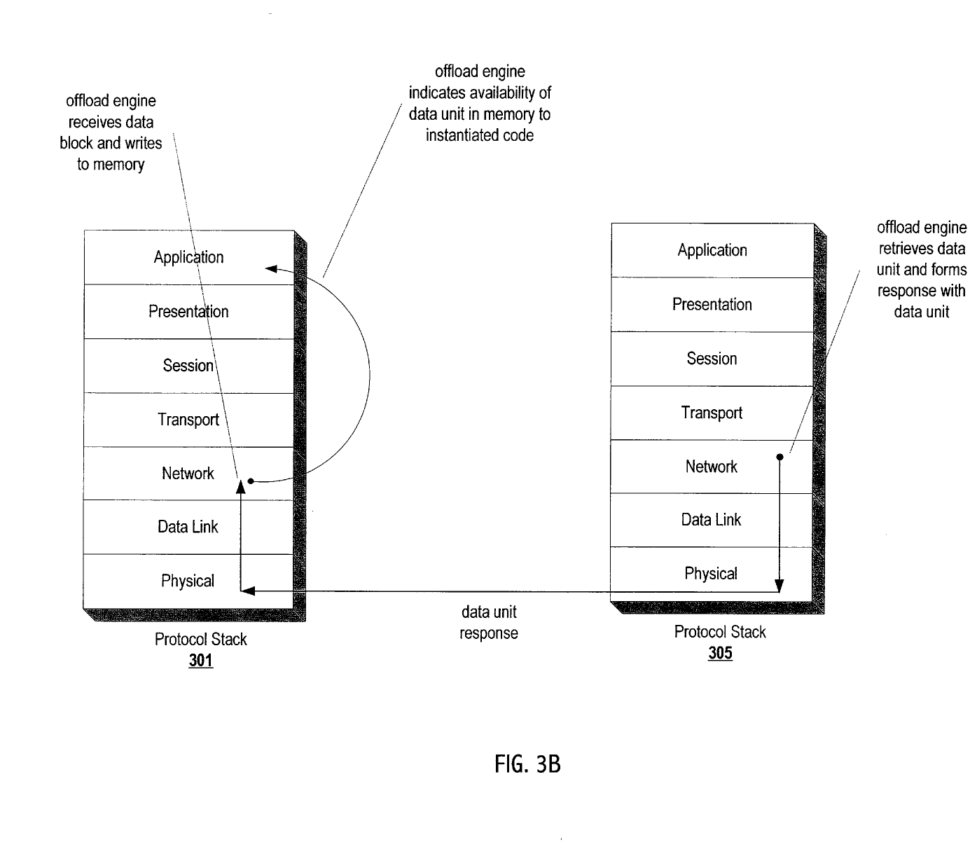

FIG. 4 depicts example hardware components of an interconnect adapter for offloading block coherency functionality to a data coherence offload engine. A system includes interconnect adapters 400a-400f. The interconnect adapter 400a includes receiver 401a, virtual channel queues 403a, multiplexer 405a, and header register(s) 407a. The interconnect adapter 400f includes receiver 401f, virtual channel queues 403f, multiplexer 405f, and header register 407f. Each of the receivers is coupled with the virtual channel queues and the data queues of their interconnect adapter. The virtual channel queues 403a are coupled with the multiplexer 405a. Likewise, the virtual channel queues 403f are coupled with the multiplexer 405f. The multiplexer 405a is coupled with the header register(s) 407a. The multiplexer 405f is coupled with the header register(s) 407f. The header register(s) 407a-407f are coupled with a multiplexer 409 that outputs to a data coherence offload engine 450. The data queue 411a is coupled with a RDMA unit 413a. The data queue 411f is coupled with a RDMA unit 413f. The RDMA units 413a-413f are coupled with a multiplexer 415 that outputs to a memory.

When a message with a requested data unit arrives at a receiver, such as receiver 401a, the receiver parses the message into a header and the requested data unit. The header is written into one of the virtual channel queues 403a. The data unit is written to the data queue 411a. The header traverses the one of the virtual channel queues 403a until eventually being selected by the multiplexer 405a and written into the header register(s) 407a. Eventually, the header is received by the data coherence offload engine 450 via the multiplexer 409. The data coherence offload engine 450 processes received headers (e.g., ACKs) and informs the instantiated code that requested data has arrived and is available in the memory. For example, the data coherence offload engine sets a flag at a location polled by the instantiated code; the offload engines causes generation of an interrupt, etc. The data unit travels through the data queue 411a until arriving at the RDMA unit 413a. The data unit is then written directly to memory by the RDMA unit 413a via the multiplexer 415.

Shared-Cache Cluster Coherence Transaction Types

The various illustrations have assumed presence of a requested data unit in the cluster without consideration of the state of the data unit and some transaction performed to maintain coherence. The following are example transactions employed in a shared-cache cluster architecture to maintain coherence.
1. Request transaction: a message is sent to the node that hosts a directory for the shared-cache cluster (directory node) if a desired data unit is not available locally.
2. Forward transaction: a message is sent by the directory node to the node providing the requested data (i.e., the current owner node), and to all sharer nodes that should invalidate or mark as stale their copies of the requested data unit if the requester is performing a write.
3. Data ship transaction: a message with requested data is sent from the data owner/provider (i.e., current owner node) to the requester node.
4. Inform transaction (Data Ack): a message is sent from the requester node to the directory node, indicating that the requester node has the data, so the directory node may update the data unit's state (if other below conditions are fulfilled).
5. Invalidation or Stale transaction (Invalidate Ack): messages are sent from the nodes that have copies of a requested data unit (i.e., sharer nodes) to the directory node to acknowledge that their copies have been marked as invalid or stale. Together with the Data Ack transaction, these transactions should indicate to the directory node when it is safe to update the data unit's state and allow another transaction for the same data unit to start.

Of course, the directory node and the current owner node or one of the sharer nodes could be one and the same. Also, the requester node and one of the sharer nodes could be one and the same.

Unless message dropping is allowed (not recommended if large performance swings are not acceptable), the different transaction types might be delivered to different input queues (different virtual channels) in receiving nodes in order to prevent deadlock.

Shared-Cache Cluster Message Types

The following illustrates example message types for implementing the above example message transactions. As stated previously, the division of labor (i.e., functionality) between the offload engine and a code executed by another hardware unit, may vary across embodiments.

Data Unit Request Message

A data coherence offload engine retrieves a desired data unit ID requested by the application and, if performing a read, determines if the data unit is in local memory. If it is, no transaction is needed (the offload engine informs the requesting application database instance that the data unit is available to be read from local memory). If the data unit is requested to perform a write or the data unit is not available in local memory, the data unit's directory is consulted. The data coherence offload engine uses the data unit ID to determine a directory ID, which identifies the directory node for that data unit.

Directory Data Unit Request Message from Requester Node to Director Node

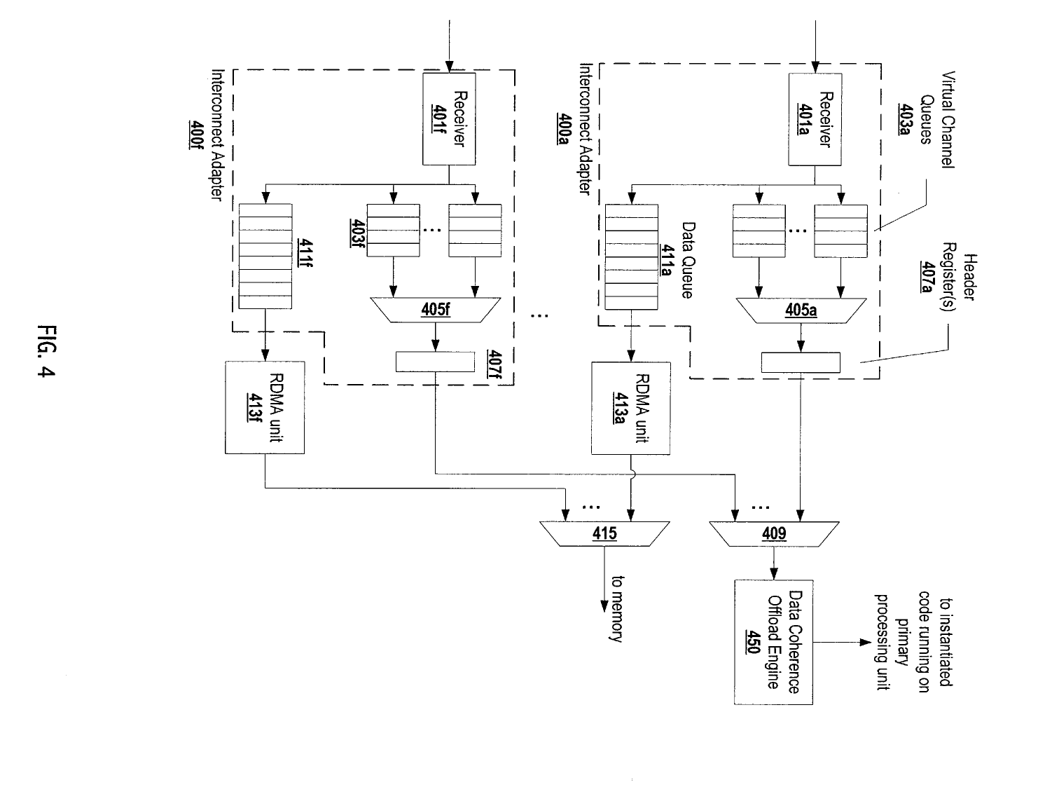

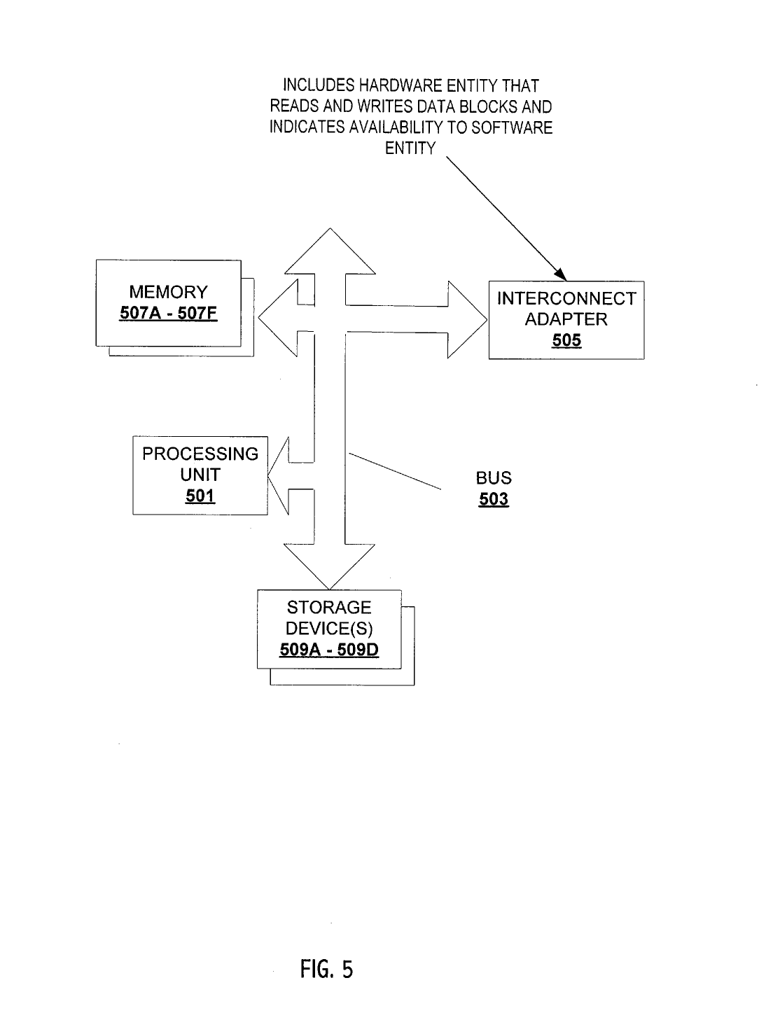

A data unit request message is forwarded to the directory node as a directory data unit request message, in order to get the state of the requested data unit. For this illustration, the directory node (like all the nodes) is assumed to have receiver logic as shown in FIG. 5, as well as one or more dedicated threads to poll the header registers holding the headers of the received messages. When one of those threads reads (polls) a valid received request message (header), it uses the received data unit ID to read the data unit's directory (to utilize the directory node's data coherence offload engine). The directory node's data coherence offload engine performs the following.
1. Translate the data unit ID into a directory entry address for that data unit.
2. Check if the data unit is locked (in use by a predecessor request); if locked, wait until unlocked.
3. Read directory entry from memory and lock the data unit (to be unlocked when a data acknowledgement message is received, or when a data acknowledgement message and invalidate/stale acknowledgement message(s) is received).
4. If the directory node is also the owner node or provider node (if the data unit is shared), then the data coherence offload engine reads the data unit and sends it (e.g., RDMA write) to the requester node. Otherwise, the data coherence offload engine issues a forward message to the data unit's owner/provider, and issues forward messages to any sharer nodes. The owner/provider node should provide the requested data directly to the requester. If the requester is performing a write on a shared data unit, then the data coherence offload engine sends forward messages to the sharer nodes to cause the sharer nodes to invalidate or mark as stale their copies of the requested data unit. A forward message(s) (or at least some of them) include indication of the directory node, destination nodes (owning and any sharing), and the requester node (this is used by the owner/provider node of that block in order to send the block directly to the requester).
5. If the requester node has a local copy of a shared data unit and wants to modify it, a “Read Private” request is submitted to the directory node. The assumption is that the directory node sends an invalidate acknowledgement message to the requester node, in order to allow the requester to commence use of the data unit. Meanwhile, the directory node sends forward messages to all other sharer nodes. The data unit is locked until the invalidate/stale acknowledgement messages are received by the directory node, at which point the data unit's state is modified and the data unit is unlocked.

Forward Message from Directory Node

The “forward” messages are messages forwarded by the directory node to the owner node or, in the case of a shared data unit, to a provider node. There are, as briefly described already, several types of “forward” messages.
1. “Read Shared” is sent to the data unit provider (or owner, depending on the state of the data unit). The data unit provider keeps the data unit as shared.
2. “Read Private” is sent to the data unit provider (or owner, depending on the state of the data unit). The data unit provider invalidates the line or keeps it as a stale copy, based on information in the Read Private request (local or global).
3. “Invalidate” (INV) is sent to the sharer nodes, except the provider node (which gets a Read Private request), when the data unit is shared local.
4. “Stale” (PI) is sent to the sharer nodes, except the provider node (which gets a Read Private request), when the line is shared global.

In our examples, a data unit's owner/provider is assumed to have receiver logic as shown in FIG. 5, as well as one or more dedicated threads to poll the header registers holding the headers of received messages, which may or may not be part of an offload engine. For purposes of these examples, it is assumed that the offload engine embodies the dedicated threads. When one of those threads reads (polls) a valid “forward” transaction (header), the offload engine uses the received data unit ID and the transaction type to handle the transaction as follows:
1. Translate received data unit ID to data unit address in memory and check if the data unit is valid. If not valid, send an interrupt to instantiated code for the error to be handled.
2. If “Read Shared” message, send a “Shared Data” message to requester node. The offload engine generates the message header, and reads the data unit from memory. The data unit becomes the message's payload. The responding node continues to be one of the sharer nodes and the data unit provider.
3. If “Read Private” message, send a “Private Data” message to requester node. The data request handler offload engine generates the message header, and reads the data unit from memory and sends it. The data unit becomes the message's payload. The offload engine also checks the local/global data unit state received with the message, in order to know whether to invalidate the message's copy or not. If local, the data unit is marked as invalid. If global, the data unit is not invalidated, but possibly marked as stale.
4. If “NV” message, the receiving node's data unit copy is invalidated, and an invalidation acknowledgement message is sent to the directory node.
5. If “PI” message, the receiving node marks its local copy of the data unit as stale, and sends a stale acknowledgement message to the directory node.

Response Message

A node issues one of the following types of response messages after receiving a request.
1. “Shared Data” is issued in response to a “Read Shared” request.
2. “Private Data” is issued in response to a “Read Private” request, when the requested data unit is in a global state (e.g., has a global lock).
3. PRIVATE_ACK is issued in response to a “Read Private” request when the requested data unit is in a shared local state.

If a requester node receives a “Shared Data” message, then the offload engine writes the data unit (i.e., the data payload) into the appropriate memory area. In this example, the data unit shouldn't be marked as private in the requester node. The directory node will indicate whether the data unit is private.

If a requester node receives a “Private Data” message, the offload engine writes the data unit into the assigned memory area. Once the data unit is in memory, the application database instance can perform either a read or write of the data unit.

If PRIVATE_ACK is received by the requester node, then the previously shared data unit is now private and can be modified (the data unit ID was mapped to the proper data unit memory address and data coherence offload engine has the data unit's address in memory). The data unit shouldn't be marked as private in the requester node, because the directory node is responsible for updating state of the data unit. However, marking the block as private locally will allow further modification without invoking the directory node. No ACK needs to be sent to the directory node by the requester node in this case.

For the above example scenarios, the data coherence offload engine handles a received message (e.g., “Read Private” and issues an INV_ACK) or interrupts the requesting application database instance, in order to inform it that the data unit is already available. For starvation reasons, it is probably the requester node that should send the “inform” message to the directory node.

Inform (ACK) Messages

The inform messages include the following:
1. Shared_Data_ACK: message sent by the requester node to the directory node if a “Shared Data” response message was received;
2. Private_Data_ACK: message sent by the requester node to the directory node if a “Private Data” response message was received;
3. PI_ACK: message sent from a sharer node to the directory node to acknowledge marking of a local copy of a globally shared data unit as stale. If an INV_ACK response message was received, no ACK is sent to the directory node by the requester node (only the INV_ACKs or PI_ACKs from the other sharer nodes should be sent to the directory node in this case).
4. INV_ACK: messages sent from a sharer node to the directory node following an invalidate request (INV). The INV_ACK acknowledges invalidation of a local copy of a globally shared data unit.

The INV_ACK and PI_ACK messages are received by the directory node in response to INV and PI messages, if such messages were issued by the directory node. The directory node also receives the Shared_Data_ACK or Private_Data_ACK messages, depending on the type of the request. The offload engine handles the “inform” messages and examines the “inform” message's header to invoke the proper code, based on the message type. This invoked code determines if all “forward” messages issued for a given data unit request are acknowledged, indicating a coherent state for the data unit in all the nodes. When the last ACK is received, the data coherence offload engine in the directory node changes the data unit's state according to the request and the previous data unit state and unlocks that data unit, allowing subsequent requests for that data unit to proceed.

Example Scenarios

The examples assume three database application instances that read and update the same data unit in a given sequence. Each of the three instances run on different nodes (Node 1, Node 2 and Node 3), with a directory node for that data unit running on a fourth node. The examples refer to block realizations of data units and to packet realizations of messages.

Block Read the First Time by Instance 3

A database instance running on Node 3 identifies a need for a block. It requests the block from the offload engine located on Node 3. The offload engine at Node 3 (the requester node) issues a Read_Shared to the directory node. An offload engine of the directory node examines the header, looks up the block ID and determines that no node has a copy of the block (the block is on a storage disk only). As a result, the data coherence offload engine assigns an entry for the block in the table (hashed or otherwise) that holds the block ID translation to the memory address where the directory (state, etc.) for the block is held. The data coherence offload engine locks the entry and waits for an ACK from the requester node that the requester node has received a copy of the block. The data coherence offload engine also issues an I/O request. When the data becomes available, data could be sent as a “Shared Data” packet to the requester node (Node 3). The data coherence offload engine of Node 3 handles the response header, and writes the block's data into the pre-assigned memory area. When the data is transferred to memory, the data coherence offload engine interrupts the Node 3 database application instance that issued the data block request, indicating that the block is available. The requesting database application instance issues (or causes the offload engine to issue) a Shared_Data_ACK packet to the directory node, before proceeding with using the block's data. The directory node's offload engine handles the Shared_Data_ACK packet by updating the block's state to shared local and unlocking the block.

Block Read by Instance 2

The database instance at Node 2 requests to read data. The offload engine at Node 2 (the requester node) issues a Read_Shared to the directory node. The offload engine of the directory node examines the header and looks up the block ID in the directory table. If the block is locked, the offload engine could go to the next queue, while keeping a current queue as the highest priority queue. Otherwise the data coherence offload engine determines that Node 3 has a copy of the block and locks the block in the directory table while waiting for the ACK from the requester node (Node 2) that it got a copy of the block. The data coherence offload engine also issues a “Read_Shared” request to Node 3 (the block provider). When the data becomes available, that node could send it as a “Shared Data” packet to the requester node (Node 2), while keeping a copy of the block. The data coherence offload engine handles the response header, and writes the block's data into the pre-assigned memory area. When the data is transferred to memory, the data coherence offload engine interrupts the Node 2 offload engine that issued the data block request, indicating that the block is available. The data coherence offload engine issues a Shared_Data_ACK packet to the directory node, before the database application instance proceeding with using the block's data. The directory node's offload engine handles the Shared_Data-ACK packet by updating the block's state to shared local for Node 2 (in addition to shared local for Node3) and unlocking the block.

Block Update by Instance 2

The database instance at Node 2 identifies interest in a block. The offload engine at Node 2 detects that is has a block of interest, but does not know if it owns the block of interest. So, the offload engine at Node 2 issues a Read_Private to the directory node. The offload engine of the directory node examines the header and looks up the block ID in the directory table. If the block is locked, the offload engine could go to the next queue, while keeping this as the highest priority queue. Otherwise the data coherence offload engine examines the block's directory and locks the block in the directory table and sends a PRIVATE_ACK to the requester node. The data coherence offload engine determines that the block is “local” and shared by Node 2 and Node 3, so the copy in Node 3 should be invalidated. As a result, the data coherence offload engine issues an “INV” request to Node 3. The offload engine in Node 3 examines the packet header and, as it is INV, invalidates the block with that block ID in its table, before issuing an INV_ACK to the directory node. The offload engine of Node 3 invokes the proper code to handle the response (INV_ACK) header. As no data transfer takes place, the data coherence offload engine at the requester node interrupts the Node 2 database application instance that issued the data block request, and indicates that the block is available and can be modified after receiving the PRIVATE_ACK from the directory node. The requesting database application instance issues (or causes the offload engine to issue) a Private_Data_ACK packet to the directory node, after updating the block's data. The directory node's offload engine handles the Private_Data-ACK packet by updating the block's state to exclusive local for Node 2 and unlocking the block. In another approach, the data coherence offload engine at the directory node waits to send the PRIVATE_ACK to the requester node until receiving INV_ACKs from all sharer nodes.

Block Update by Instance 1

The offload engine at Node 1 requests a block as private, in order to modify it, by issuing a Read_Private request to the directory node. The offload engine of the directory node examines the header and looks up the block ID in the directory table. If the block is locked, the offload engine could go to the next queue, while keeping this as the highest priority queue. Otherwise the data coherence offload engine examines the block's directory and locks the block in the directory table while waiting for the Private_Data_ACK from the requester node that it got a copy of the block. The data coherence offload engine determines that the block is “local” and owned by Node 2, so it issues a “Read_Private” with the global bit asserted, indicating that Node 2 should send the data to the requester node, while keeping a copy of the block as PI. The offload engine in Node 2 examines the packet header and, as it is “Read_Private” with the global bit asserted, it marks the block with that block ID as PI in its table and reads the block's data from memory into the “Private_Data” packet it sends back to the requester (Node 1). The offload engine of Node 1 invokes the proper code to handle the response header, while the data coherence offload engine writes the block's data into the pre-assigned memory area. When the data is transferred to memory, the data coherence offload engine interrupts the Node 1 database application instance that issued the data block request, indicating that the block is available. The database application instance issues (or causes the offload engine to issue) a Private_Data-ACK packet to the directory node, before proceeding with using the block's data. However, the Private_Data-Ack may also be delayed until after using the block's data to address concerns of starvation. The directory node's offload engine handles the Private_Data_ACK packet by updating the block's state to exclusive global for Node 1 and global null for Node 2 and unlocking the block.

The described embodiments may include a computer program product, or software, that may include a machine-readable medium having stored thereon instructions, which may be used to program a computer system (or other electronic devices) to perform a process according to the present embodiments. A machine readable medium includes any mechanism for storing or transmitting information in a form (e.g., software, processing application) readable by a machine (e.g., a computer). The machine-readable medium may include, but is not limited to, magnetic storage medium (e.g., floppy diskette); optical storage medium (e.g., CD-ROM); magneto-optical storage medium; read only memory (ROM); random access memory (RAM); erasable programmable memory (e.g., EPROM and EEPROM); flash memory; electrical, optical, acoustical or other form of propagated signal (e.g., carrier waves, infrared signals, digital signals, etc.); or other types of medium suitable for storing electronic instructions.

FIG. 5 depicts an example computer system. A computer system includes a processor unit 501 (possibly including multiple processors, multiple cores, multiple nodes, and/or implementing multi-threading, etc.). The computer system includes memory 507A-507F. The memory 507A-507F may be system memory (e.g., one or more of cache, SRAM, DRAM, RDRAM, EDO RAM, DDR RAM, EEPROM, etc.) or any one or more of the above already described possible realizations of machine-readable media. The computer system also includes a bus 503 (e.g., PCI, ISA, PCI-Express, HyperTransport, InfiniBand, NuBus, etc.), an interconnect adapter 505 (e.g., an ATM interface, an Ethernet interface, a Frame Relay interface, etc.), and a storage device(s) 509A-509D (e.g., optical storage, magnetic storage, etc.). The interconnect adapter 505 includes a data coherence offload engine that reads and writes data units into either one or both of the storage device(s) 509A-509D and the system memory 507A-507F, and that indicates availability of a data unit to a instantiated code supported by the processor unit 501. In another example, the data coherence offload engine is separate from the interconnect adapter 505 and coupled to receive data units from the interconnect adapter 505. Realizations may include fewer or additional components not illustrated in FIG. 5 (e.g., video cards, audio cards, additional network interfaces, peripheral devices, etc.). The processor unit 501, the storage device(s) 509A-509D, and the interconnect adapter 505 are coupled to the bus 503. The memory 507A-507F is either coupled directly or indirectly to the bus 503.

While the invention has been described with reference to various realizations, it will be understood that these realizations are illustrative and that the scope of the invention is not limited to them. Many variations, modifications, additions, and improvements are possible. More generally, realizations in accordance with the present invention have been described in the context of particular realizations. These realizations are meant to be illustrative and not limiting. Accordingly, plural instances may be provided for components described herein as a single instance. Boundaries between various components, operations and data stores are somewhat arbitrary, and particular operations are illustrated in the context of specific illustrative configurations. Other allocations of functionality are envisioned and may fall within the scope of claims that follow. Finally, structures and functionality presented as discrete components in the exemplary configurations may be implemented as a combined structure or component. These and other variations, modifications, additions, and improvements may fall within the scope of the invention as defined in the claims that follow.

What is claimed is:

1. A method for offloading, from a set of one or more primary processing units, one or more data coherence operations in a cluster that maintains application level data coherence across nodes in the cluster, the method comprising:
utilizing a data coherence offload engine of a first node in the cluster to perform the one or more data coherence operations to reduce workload on the set of primary processing units responsive to a request from the primary processing units at the first node; and
communicating one or more result of the one or more data coherence operations performed by the data coherence offload engine to the first of the primary processing units,
wherein the data coherence offload engine is distinct from the set of primary processing units.

2. The method of claim 1, wherein the data coherence operations comprise at least one of writing a requested data unit to memory, retrieving a requested data unit, consulting a directory for location of a requested data unit, maintaining the directory, generating request messages, generating response messages, generating inform messages, and generating forward messages.

3. The method of claim 2, wherein the communicating comprises the data coherence offload engine indicating to the set of primary processing units availability of a requested data unit in the memory.

4. The method of claim 3, wherein indicating comprises causing interruption of the at least one of the set of primary processing units.

5. The method of claim 3, wherein the indicating comprises the data coherence offload engine setting a value at a hardware location polled by at least one of the primary processing units.

6. The method of claim 1, wherein the data coherence offload engine executes one or more threads to examine headers of messages to handle the messages appropriately.

7. The method of claim 1 embodied as a computer program product encoded in one or more machine-readable media.

8. A node in a shared-cache cluster comprising:
one or more primary processing units operable to instantiate code that performs one or more operations to maintain application level data coherence in the shared-cache cluster;
a memory;
an interconnect adapter operable to communicatively couple the node to the shared-cache cluster and having a plurality of receive and transmit buffers and header buffers; and
a data coherence offload engine coupled with the interconnect adapter, the memory, and at least one of the one or more primary processing units, the data coherence offload engine operable to perform at least one of the one or more operations to maintain data coherence and operable to defer to the one or more primary processing units for complex operations.

9. The node of claim 8, wherein the data coherence offload engine is operable to write a requested data unit to the memory and to indicate availability of the requested data unit in the memory to the one or more primary processing units.

10. The node of claim 9 further comprising a store element coupled with the one or more primary processing units, the data coherence offload engine operable to set a value in the store element indicate availability of a requested data unit in the memory, wherein at least one of the one or more primary processing units is operable to instantiate code that polls the store element.

11. The node of claim 9, wherein the data coherence offload engine is operable to generate an interrupt to at least one of the one or more primary processing units to indicate availability of a requested data unit in the memory.

12. The node of claim 8, wherein the one or more operations comprise at least one of writing a requested data unit to memory, retrieving a requested data unit, consulting a directory for location of a requested data unit, maintaining the directory, generating request messages, generating response messages, generating inform messages, and generating forward messages.

13. The node of claim 8, wherein the data coherence offload engine comprises one or more of a complex programmable device, a field programmable gate array, and an application specific integrated circuit.

14. The node of claim 7, wherein the data coherence offload engine is operable to execute one or more threads to examine message header information stored in the header buffers of the interconnect adapter to determine handling of a received message.

15. The node of claim 7, wherein the data coherence offload engine is operable to invoke code instantiated by the one or more primary processing units to handle a data coherence message.

16. An apparatus comprising:
means for performing one or more data coherence operations that correspond to a data unit request in accordance with an application level data coherence protocol of a shared-cache cluster, wherein a primary processing unit initiates the data unit request; and
means for writing a requested data unit into a memory;
means for indicating to the primary processing unit availability of a requested data unit in the memory.

17. The apparatus of claim 16, wherein the indicating means generates an interrupt to the primary processing unit to indicate availability of a requested data unit.

18. The apparatus of claim 16, wherein the indicating means sets a value in a register to indicate availability of a requested data unit, wherein the primary processing unit polls the register.

19. The apparatus of claim 16 further comprising means for maintaining a directory that indicates state and location of data units in the cluster.
